(19) United States
(12) Patent Application Publication
(10) Pub. No.: US 2005/0200675 A1
(43) Pub. Date: Sep. 15, 2005

(54) Method and apparatus for converting substrates bearing ink images on the substrate with a converting belt apparatus

(76) Inventors: Jiann-Hsing Chen, Fairport, NY (US); Joseph A. Pavlisko, Pittsford, NY (US); Nataly Boulatnikov, Rochester, NY (US)

Correspondence Address: Mark G. Bocchetti;Patent Legal Staff, Eastman Kodak Company, 343 State Street, Rochester, NY, 14650-2201, US

(21) Appl. No.: 11/038,925

(22) Filed: Jan. 19, 2005

Related U.S. Application Data
(60) Provisional application No. 60/543,070, filed on Feb. 9, 2004.

(51) Int. Cl. B41J 2/01

(52) U.S. Cl. 347/102

(57) ABSTRACT

A method and apparatus in which a converting belt system belt is coated with a composition suitable for use with ink image-bearing substrates that require ink drying, fusing, or both for the ink image-bearing substrates to improve various durability and other properties of the ink image-bearing substrates.

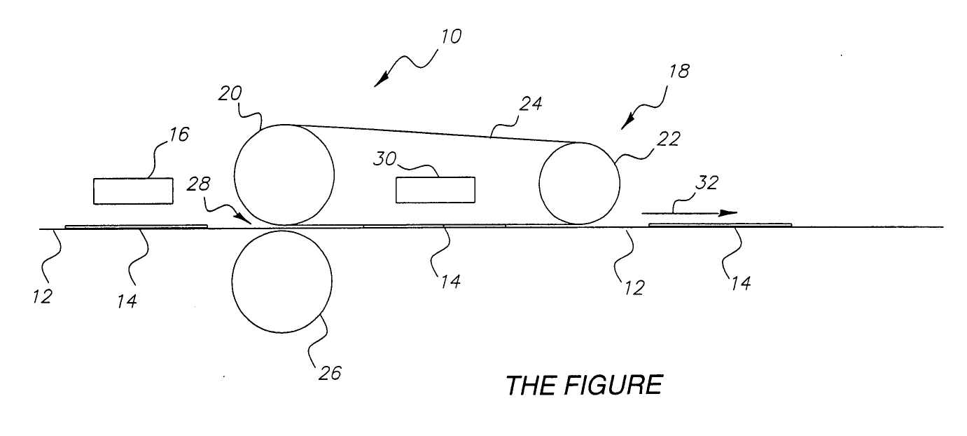

### FIELD OF THE INVENTION

This invention relates to a converting belt apparatus and a method for drying, fusing, or both ink images on a substrate.

### BACKGROUND OF THE INVENTION

Inkjet printing is a non-impact printing method that, in response to a digital signal, produces droplets of ink that are deposited on a recording element. Today, inkjet printing systems are used in a variety of capacities in industrial, home, and office environments. The quality of inkjet prints continues to improve, however, inkjet prints are disadvantaged because they lack durability, often being less stable relative to environmental factors (light, ozone, etc.) and more sensitive to water and abrasion.

One way of overcoming these disadvantages is to laminate or encapsulated inkjet prints. When an inkjet print is laminated, a transparent overlay is adhered to the inkjet print. Typically, this is accomplished using an adhesive activated by heat, pressure, or both. The transparent overlay physically protects the print and seals it from ingress of water. When an inkjet print is encapsulated, the print is positioned between two laminating sheets, at least one of which is transparent. Then some combination of the print and the laminating sheets are adhered usually using an adhesive activated by heat, pressure, or both. Typically, encapsulation is most effective when the laminating sheets extend beyond the print and are bonded to each other at the extremities, thus preventing ingress of water through exposed edges of the print.

Lamination and encapsulation both have disadvantages in that they are expensive processes requiring additional materials and handling by the user. Moreover, inkjet inks remained trapped within the recording element and can degrade image quality by causing stain or migration of the print on storage or exposure. Laminate materials and adhesives can often deteriorate over time causing surface defects including, for example, cracking. Laminates do not always adhere well to inkjet prints. The quality and uniformity of adhesion can depend on the material nature of the recording element, the type of ink, and the volume of ink printed per unit area of recording element (ink laydown). The latter is particularly significant when the inkjet print has photographic image quality because heavy laydowns of ink are necessary to achieve the necessary superb image quality.

As an alternative to lamination or encapsulation, inkjet recording elements having a nascent protective layer coated on a support are known. The nascent protective layer is really a special chemical layer designed such that during the inkjet printing process, the inks penetrate the layer, and after printing is complete, the layer is fused using heat and/or pressure so that it seals and protects the print. This process is often referred to as the incorporated approach because the nascent protective material is incorporated into the recording element during its production.

However, the incorporated approach is limited because it is difficult to obtain a final protected print that is uniform in haze and clarity and free of surface defects such as blistering and cracking. Limitations are especially apparent when the final protected print must have superb image quality, e.g., when it is for photographic or medical diagnostic applications. A recording element for these applications should have not only a nascent protective layer, but also at least one underlying layer, or ink-receiving layer, the function of which is to help manage a heavy laydown of ink. After printing, the bulk of the ink, commonly referred to as the carrier, is retained somewhere in the dual layer system. If too much carrier resides in the nascent protective layer during fusing, it will not fuse properly and any of the aforementioned undesirable effects may be observed.

This condition worsens when the carrier resides predominately in an ink-receiving layer during and/or after fusing of the nascent protective layer, and then migrates within the ink-receiving layer, or from the ink-receiving layer and into the fused protective layer. Migration of the carrier within the ink-receiving layer causes deterioration of image quality, e.g., loss of image sharpness and blotchiness, and migration into the fused protective layer causes any of the aforementioned undesirable effects.

There is a need for providing a converting station that is able to generate a high quality throughtput and durable characteristics. Ink images formed on substrates by other techniques exhibit similar problems.

Some ink images may be formed using inks that include fusable components such as those polymeric constituents typically used for electrophotographic image production. Such constituents can be used in inks of various colors and may be used in significant quantities in the inks. With such inks, it is possible to fuse the inks to achieve improved durability and other improved characteristics.

Accordingly, improved processes have been sought for the development of such improved ink images.

### SUMMARY OF THE INVENTION

According to the present invention, it has been found that improved characteristics are achieved by a method for improving at least one property of an ink image on a substrate, the method comprising: drying the ink image in a drying step to remove at least a major portion of the ink carrier; and, passing the substrate through a nip defined by a fuser roller and a pressure roller in a converting belt system.

The invention further comprises an apparatus for improving at least one property of an ink image on a substrate, the apparatus comprising: a drier adapted to remove at least a major portion of the carrier from the ink images; a converting belt system for further drying or fusing the ink image; and, a conveyor system operable to transport the substrate through the drier and the converting belt system for further drying or fusing.

### BRIEF DESCRIPTION OF THE DRAWING

The FIGURE schematically depicts an embodiment of an apparatus for use in the practice of the method of the present invention.

### DETAILED DESCRIPTION OF THE INVENTION

In the description of the FIGURE, the same numbers will be used throughout to refer to the same or similar components.

In the FIGURE, a conveyor 12 which will be understood to comprise one or a plurality of conveyors is shown in a system 10, which comprises a converting belt system 18. The system is adapted to treat substrates 14 bearing ink images, which are passed along conveyor 12 through a drier schematically shown at 16, which may be a hot air drier, an infrared drier, a conduction heat drier or the like as known to those skilled in the art for the removal of carrier materials from the ink images on the substrates. Carrier materials are typically water, volatile organic solvents and the like.

The substrates, after passing through drier 16 are passed to converting belt system 18. Converting belt system 18 comprises a first fuser roller 20 and a second roller 22, with a belt 24 around the two rollers. Fuser roller 20 is positioned next to a pressure roller 26 to form a nip 28 between the rollers through which the substrates are passed. The substrates are typically further dried or fused in the nip. Typically the substrates pass through the nip at up to about 15 cm/sec. and preferably from about 0.5 to about 15 cm/sec. The substrates bearing the ink images may be cooled in a cooler 30 downstream from the nip. The substrates are moved along conveyor 18 as shown in the direction shown by an arrow 32.

The converting belt system belt 24 may comprise a composite material consisting of a substrate and disposed on the substrate an ink release surface layer formed from a composition that comprises a silsesquioxane and a curable phenolic resin. On curing, the composition forms an inter penetrating polymer network of the silsesquioxane and phenolic resin. Such coatings are considered to be known to those skilled in the art. The belt may comprise a polyamide resin such as described in U.S. Pat. No. 5,778,295.

While such belts and coatings are considered to be known, the composition will be described briefly as follows.

Silsesquioxanes are a class of inorganic/organic glasses that can be formed at moderate temperatures by a procedure commonly referred to as a “sol-gel” process. In the sol-gel process, silicon alkoxides are hydrolyzed in an appropriate solvent, forming the “sol.” The solvent is then removed, resulting in the formation of a cross-linked “gel.” A variety of solvents can be used, aqueous, aqueous-alcoholic, and alcoholic solvents being generally preferred. Silsesquioxane are conveniently coated from acidic alcohols, since the silicic acid form (RSi(OH)₃, is quite stable in solution for months under ambient conditions. The extent of condensation is related to the amount of curing a sample received, temperature and time being among the two most important variables.

Silsesquioxane can be represented by the formula (RSiO_{1.5})ₙ, where R is an organic group and n is the number of repeating units. Thus, the prefix “sesqui” refers to a one and one-half stoichiometry of oxygen. The polymers can be prepared by the hydrolysis and condensation of trialkoxysilanes. U.S. Pat. No. 4,027,073 teaches the use of silsesquioxanes as abrasion resistant coatings on organic polymers. Typical applications include scratch resistant coatings on acrylic lenses and transparent glazing materials. The cited patent teaches that a preferred thickness for good scratch resistance is from 2 to 10 μm. U.S. Pat. No. 4,439,509 teaches photo-conducting elements for electrophotography that have silsesquioxane coatings having a thickness of 0.5 to 2.0 μm, which is purported to optimize electrical, transfer, cleaning and scratch resistance properties. This teaching contrasts with that of U.S. Pat. No. 4,027,073, which teaches that a preferred thickness of a silsesquioxane layer for good scratch resistance is from 2 to 10μ. U.S. Pat. No. 4,923,775 teaches that methylsilsesquioxane is preferred since it produces the hardest material in comparison to other alkysilanes. U.S. Pat. No. 4,595,602 teaches a conductive overcoat of cross-linked “siloxanol-colloidal silica hybrid” having a preferred thickness of from 0.3 to 5.0μ. The disclosures of all of the patents cited herein are incorporated herein by reference.

The formula (RSiO_{1.5})ₙ above, which is sometimes written [Si(O_{0.5})₃Rₙ], is a useful shorthand for silsesquioxanes but, except for fully cured silsesquioxane, it does not totally characterize the material. This is important, since silsesquioxanes can be utilized in an incompletely cured state. An additional nomenclature, derived from one described in R. H. Glaser, G. L. Wilkes, C. E. Bronnimann; Journal of Non-Crystalline Solids, 113 (1989) 73-87, uses the initials M, D, T and Q to designate silicon atoms bonded to 1, 2, 3, or 4 oxygen atoms, respectively. The designation T is subdivided to indicate the number of —Si—O—Si bonds, from 0 to 3, contained in the silsesquioxane structure, i.e., T⁰, T¹, T², and T³.

In fully cured silsesquioxanes, substantially all silicons are included in T³ structures. The extent of curing of the silsesquioxane can be quantified as the ratio of T² to T³. The value of this T²/T³ ratio decreases with an increase in cure and vice versa. In the silsesquioxanes having the most advantageous properties for inclusion in a toner fusing belt surface layer, the ratio of carbon to silicon atoms, i.e., the C:Si ratio, is greater than about 2:1 and the T²/T³ ratio is from about 0.5:1 to about 0.1:1. The silsesquioxane is a large oligomer or a polymer typically containing more than 10 silsesquioxane subunits, although theoretically there is no upper limit on the number of subunits.

Phenolic resins, which were the earliest commercially developed synthetic polymers, are formed by the reaction of phenol or its substituted derivatives, for example, cresols, xylenols, and butylphenols, with aldehyde compounds such as formaldehyde, acetaldehye and furfural. There are two classes of phenolic resins: novolacs and resoles. Novalac resins, which are formed by an acid-catalyzed reaction of a molar excess of a phenol with an aldehyde, i.e., a molar ratio greater than one, are thermoplastic, requiring the addition of a cross-linking agent to form a three-dimensional rigid polymer network. Resole resins, which are formed by a base-catalyzed reaction of a phenol with a molar excess of an aldehyde, i.e., a molar ratio less than one, are thermoset. The phenolic resins employed in the compositions of the present invention are curable novalac resins.

While fuser member surface layers formed from silsesquioxane sol-gels have good toner release properties, they tend to be brittle, resulting in poor wear characteristics. a coating composition of the present invention, in which a silsesquioxane is combined with a curable phenolic resin, forms an interpenetrating polymer network (IPN) upon curing, thereby providing a tough release layer having excellent wear characteristics. The coating composition contains the silsesquioxane and phenolic resin in a silsesquioxane:phenolic resin weight ratio, preferably of about 1:10 to about 10:1, more preferably about 1.5 to about 1:1.

The toner release surface layer composition of the present invention may further include a filler, such as; SiO₂, TiO₂, ZnO, SnO₂, Al₂O₃, or mixtures thereof, in an amount ranging from about 1 weight percent (wt. %) to about 30 wt. %. Preferably, the filler is SiO₂, in an amount from about 1 wt. % to about 7 wt. %.

Other surface compositions known to that art could also be used, such as poly (dialkylsiloxanes).

In the practice of the method of the present invention, the substrates bearing ink images are dried in drier 16 to remove at least 50 wt. % and preferably at least 80 wt. % and even more preferably at least 85 wt. % and still more preferably at least 90 wt. % of the ink carrier present in the ink images. The substrates bearing the ink images are then passed through nip 28 where they are subjected to heat and pressure treatment by rollers 20 and 26. Rollers 20 and 26 may be operated to further dry the ink images on the substrate or they may be used to fuse the ink images on the substrate if the inks contain fisable components. Even if the inks do not include fusable materials, it may be desirable to operate rollers 20 and 26 in a fusable mode if nascent protective layers are included in the substrate. The substrate bearing the fused or further dried image is then passed via conveyor 12 to cooling in a cooler 30. Cooling in cooler 30 is optional and may not be required in all instances. It is, however, required that the substrate be dried in drier 16 to remove sufficient carrier so that the images are not damaged by further treatment in nip 28 by the vaporization of carrier to form blisters, artifacts or the like in the image. Treatment in the nip removes additional quantities of moisture and by pressure and temperature treatment tends to fix the ink images to the substrate more firmly. This is particularly important when fusable inks are used and particularly when colored inks are used. The method of the present invention is particularly useful in producing colored images, which include inks of different colors. The fusing tends to fix the inks in position and prevent bleeding between the colors and the like.

### EXAMPLE

### Post-Printing Treatment—Ink Carrier Removal Step

A carrier removal drier consisting of an IR lamp and forced air was employed in the example. For the IR lamp, a K1100 infrared emitter module, a trademark of Heraeus Noblelight, Inc., was used. This module consisted of a medium wave twintube carbon emitter with a gold reflector operating at a total bank power of 2200 watts and housed in high temperature stainless steel housing. The heated length of the module was 30 cm. The color temperature of the IR lamp was varied by adjusting, using a standard variable autotransformer, the amount of voltage delivered to the module. Ambient forced air was delivered using an EXAIR, trademark of Exair Corp., standard air knife, (at a gap setting 0.05 mm, with a length of 30 cm). The line pressure of the air delivered to the air knife was 4.9 kg/cm² (70 psi).

Carrier was removed from each of the five printed samples described above as follows. Immediately after printing, a printed sample was laid on a unidirectional platen, about 30 by 30 cm, and held flat by an aluminum metal frame that contacted the outer edges of the imaged inkjet recording element (but not the single density patch). The platen transported the printed sample at a rate of 2.5 cm/sec underneath the IR lamp positioned about 7.6 cm above the platen. After passing by the IR lamp, the printed sample passed underneath the air knife positioned about 11.4 cm from the IR lamp and about 7.0 cm above the platen. Air from the air knife was directed at the platen at an angle of about 20° relative to the plane of the platen such that it was blown over the complete surface of the imaged recording element. For each printed sample, the voltage delivered to the IR lamp was varied such that the amount of carrier removed varied proportionately. Each sample was weighed immediately after it passed completely by the air knife. The amount of carrier removed was determined, and the results are shown in Table 1.

### EXAMPLE

### Post-Printing Treatment—Converting Step

A converting station consisting of a belt-fusing system was employed in the example. Such systems are well known to those skilled in the art of electrophotographic copying and are disclosed, for example, in U.S. Pat. Nos. 5,258,256 and 5,783,348. The belt-fusing system consisted of a belt around a pair of stainless steel rollers. The belt was approximately 33 cm wide and consisted of KAPTON, trademark of E.I. du Pont de Nemours and Co., polyamide film coated with a silicon-containing polymer as disclosed in U.S. Provisional Patent Application Ser. No. 60/533,126 filed on Dec. 24, 2003, by Jiann-Hsing Chen, Joseph A. Pavlisko, Muhammed Aslam, and Wayne T. Ferrar, provided by NexPress Solutions, Inc. One of the stainless steel rollers was 6.9 cm in diameter and functioned as the fusing roller; the other stainless steel roller was 2.5 cm in diameter. Both rollers were 36 cm wide, and the distance between the two rollers was 23.0 cm (from center to center).

The fusing roller was positioned next to a third roller, 7.6 cm in diameter and 36 cm wide, which functioned as the pressure roller. The pressure roller was a stainless steel roller coated with silicon-rubber having a thickness of about 0.45 cm and a durometer hardness of about 85 Shore A units. The fusing and pressure rollers were positioned such that the nip width was 0.64 cm (0.25 in.) and the nip pressure was 4.6 kg/cm² (65 psi). Both the fusing and pressure rollers were hollow and were heated using lamps housed therein and along the axial direction. Temperature sensors were used to maintain constant temperature of the surfaces of the rollers, which was 149° C. for the fusing roller and 99° C. for the pressure roller.

After weighing each of the samples after the carrier removal step, each was passed through the belt fusing system at a transport rate of about 0.89 cm/sec and subsequently evaluated for artifacts. The results are shown in table 1. Blistering is undesirable and appears as rough spots in which at least one of the media layers blisters or swells to form a bubble, which then ruptures. Blistering is presumably caused by diffusion of water through and out of the topmost fusible layer of the media, i.e. evaporation of the water, as a result of heating during the converting step.

TABLE 1

| | | Sample Weight (mg) | | | | | |
|---|---|---|---|---|---|---|---|
| | | | Immediately | | | Carrier | Artifacts |
| | Voltage | Before | After | After Carrier | | Removed | After |
| # | (V) | Printing | Printing | Removal Step | Change | (wt. %) | Fusing |
| 1 | 83.4 | 5454.25 | 5623.25 | 5493.45 | 129.80 | 94.7 | none |
| 2 | 74.8 | 5520.33 | 5689.33 | 5564.32 | 125.01 | 91.2 | none |
| 3 | 65.2 | 5444.37 | 5613.37 | 5491.34 | 122.03 | 89.1 | none |
| 4 | 56.4 | 5445.62 | 5614.62 | 5497.01 | 117.61 | 85.8 | blistering |
| 5 | 48.1 | 5433.23 | 5602.23 | 5494.02 | 108.21 | 79.0 | blistering |

Upon fusing the substrates in the belt fusing system, it is clear that blistering occurred with the substrates wherein the images were not dried by reduction of the carrier content by at least 85 percent. This blistering results in defects in the printed image and is unacceptable. Various degrees of drying may be required with different inks, but in all instances the inks must be dried to a level such that blistering and other defects do not occur during the fusing operation in the practice of the present invention.

As indicated previously, improvements are considered to occur when fusing is used, particularly with inks containing fusable constituents and also with inks that may not contain fusable constituents by virtue of the first drying and the heat and pressure treatment imposed by passing the substrates through rollers 20 and 26.

The apparatus for performing the operations described above has been discussed briefly in the description of the FIGURE and will not be discussed further.

While the present invention has been described by reference to certain of its preferred embodiments, it is pointed out that the embodiments described are illustrative rather than limiting in nature and that many variations and modifications are possible within the scope of the present invention.

1. A method for improving at least one property of an ink image printed on a substrate, the method comprising:
a) drying the ink image in a drying step to remove at least a major portion of the ink carrier; and
b) passing the substrate through a nip defined by a fuser roller and a pressure roller in a converter belt system.

2. The method of claim 1, wherein the ink image is an inkjet image.

3. The method of claim 1, wherein at least a quantity of ink carrier sufficient to prevent artifacts upon drying or fusing in a belt fusing system is removed in the drying step.

4. The method of claim 1, wherein at least 80 weight percent of the ink carrier initially present in the ink is removed in the drying step.

5. The method of claim 1, wherein at least 85 weight percent of the ink carrier initially present in the ink is removed in the drying step.

6. The method of claim 1, wherein at least 90 weight percent of the ink carrier initially present in the ink is removed in the drying step.

7. The method of claim 1, wherein a belt in the belt fusing system is coated with a composition comprising a silsesquioxane or a cross-linked poly(dialkylsiloxane) containing an oxide filler.

8. The method of claim 1, wherein the substrate comprises a nascent protective layer.

9. The method of claim 1, wherein the ink contains fusible components.

10. The method of claim 1, wherein the fuser and pressure roller are at a temperature below a fusing temperature.

11. The method of claim 1, wherein the fuser and pressure roller are at a temperature sufficient to fuse a nascent protective layer or a fusible ink.

12. The method of claim 1, wherein the printed ink image is dried in the drying step with a heated air stream.

13. The method of claim 1, wherein the substrate bearing an ink image is passed through the nip at a rate of about 0.5 to about 15 cm/sec.

14. The method of claim 1, wherein the ink image is an inkjet ink image.

15. The method of claim 1, wherein the ink image is a printed inkjet ink image.

16. The method of claim 1, wherein the ink image comprises an image containing a plurality of different color inks.

17. The method of claim 16, wherein at least a portion of the inks contain fusible constituents.

18. The method of claim 1, wherein the substrate is cooled after passing through the nip.

19. The method of claim 1, wherein the durability of the ink image is improved.

20. An apparatus for improving at least one property of an ink image printed on a substrate, the apparatus comprising:
a) a drier adapted to remove at least a major portion of a carrier from the ink image;
b) a converting belt system for further drying or fusing the ink image; and
c) a conveyor system operable to transport the substrate through the drier and the converter belt system for further drying or fusing.

21. The apparatus of claim 20, wherein the drier is adapted to remove from about 50 to about 95 weight percent of the carrier from the ink image.

22. The apparatus of claim 20, wherein the converter belt system for further drying or fusing comprises a belt positioned around a first and a second roller with the first roller comprising a fuser roller and the second roller comprising a pressure roller positioned to form a nip with the fusing roller.

23. The apparatus of claim 22, wherein the apparatus includes a cooler adapted to cool the substrate after the substrate has passed through the nip.
